(19) United States
(12) Patent Application Publication
(10) Pub. No.: US 2006/0070411 A1
(43) Pub. Date: Apr. 6, 2006

(54) Magnetic spring clamp

(75) Inventors: Wing K. Ho, Boynton Beach, FL (US); Franklin H. Valade JR., Lake Worth, FL (US); Roy C. Hannes, Sunrise, FL (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronics Corporation

(21) Appl. No.: 10/958,118

(22) Filed: Oct. 4, 2004

(51) Int. Cl. E05B 65/00

(52) U.S. Cl. 70/57.1

(57) ABSTRACT

Systems, apparatuses, and methods for forming and using a magnetic spring clamp.

### BACKGROUND

A spring clamp is a clamp that is used to retain a tack or similar apparatus and resist removal of that tack until a desired torque is applied to the spring clamp. Spring clamps have been used in connection with Electronic Article Surveillance (EAS) systems, which are designed to prevent unauthorized removal of an item from a controlled area. A typical EAS system may comprise a monitoring system and one or more security tags. The monitoring system may create a surveillance zone at an access point for the controlled area. A security tag may be fastened to the monitored item, such as an article of clothing. If the monitored item enters the surveillance zone, an alarm may be triggered indicating unauthorized removal.

The security tag may be fastened to a number of different items by way of the spring clamp and tack. It may be desirable for the fastening system to allow authorized release of the security tag, while making unauthorized release relatively difficult. Consequently, there may be a need for an improved spring clamp and a technique for utilizing the improved spring clamp. Such an improved spring clamp may furthermore make unauthorized removal of the tack from the spring clamp more difficult and/or authorized removal of the tack less difficult.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a top view of an embodiment of a spring clamp;

FIG. 2 illustrates a side view of the spring clamp depicted in FIG. 1;

FIG. 3 illustrates a side view of an embodiment of a magnetic spring clamp;

FIG. 4 illustrates an isometric view of another embodiment of a magnetic spring clamp;

FIG. 5 illustrates a top view of the magnetic spring clamp of FIG. 4;

FIG. 6 illustrates a side view of the magnetic spring clamp of FIGS. 4 and 5;

FIG. 7 illustrates an end view of the magnetic spring clamp of FIGS. 4-6;

FIG. 8 illustrates a side view of an embodiment of a magnetic spring clamp with overlapping side arms;

FIG. 9 illustrates a top view of the magnetic spring clamp with side arms of FIG. 8;

FIG. 10 illustrates an isometric view of another embodiment of a magnetic spring clamp with overlapping side arms;

FIG. 11 illustrates a top view of the magnetic spring clamp with overlapping side arms of FIG. 10;

FIG. 12 illustrates a side view of the magnetic spring clamp with overlapping side arms of FIGS. 10 and 11;

FIG. 13 illustrates an end view of the magnetic spring clamp with overlapping side arms of FIGS. 10-12.

FIG. 14 illustrates an isometric view of an embodiment of a magnetic spring clamp with thickened arms and side arms;

FIG. 15 illustrates a top view of the magnetic spring clamp with thickened arms and side arms of FIG. 14;

FIG. 16 illustrates a side view of the magnetic spring clamp with thickened arms and side arms of FIGS. 14 and 15;

FIG. 17 illustrates an end view of the magnetic spring clamp with thickened arms and side arms of FIGS. 14-16;

FIG. 18 illustrates an embodiment of a magnetic spring clamp having flanges;

FIG. 19 illustrates a top view of the magnetic spring clamp having flanges of FIG. 18;

FIG. 20 illustrates a side view of the magnetic spring clamp having flanges of FIGS. 18 and 19;

FIG. 21 illustrates an end view of the magnetic spring clamp having flanges of FIGS. 18-20;

FIG. 22 illustrates a top view of an embodiment of a magnetic spring clamp with side arms that do not overlap;

FIG. 23 illustrates a top view of another embodiment of a magnetic spring clamp with side arms that do not overlap;

FIG. 24 illustrates a side view of an embodiment of a magnetic spring clamp with side arms that do not overlap;

FIG. 25 illustrates a first embodiment of a detaching magnet;

FIG. 26 illustrates a second embodiment of a detaching magnet;

FIG. 27 illustrates a third embodiment of a detaching magnet;

FIG. 28 illustrates a side view of another embodiment of a magnetic spring clamp having a magnet attached to each arm;

FIG. 29 illustrates an isometric view of another embodiment of a magnetic spring clamp having a magnet attached to each arm;

FIG. 30 illustrates a top view of the magnetic spring clamp of FIG. 29 having a magnet attached to each arm;

FIG. 31 illustrates a side view of the magnetic spring clamp of FIGS. 29 and 30 having a magnet attached to each arm;

FIG. 32 illustrates an end view of the magnetic spring clamp of FIGS. 29-31 having a magnet attached to each arm;

FIG. 33 illustrates an embodiment of a two plate spreading symmetric jaw magnetic spring clamp 400; and

FIG. 34 illustrates an embodiment of a two plate spreading asymmetric jaw magnetic spring clamp 450.

### DETAILED DESCRIPTION

The embodiments are directed to a magnetic spring clamp and techniques for attaching a fastening element to and detaching a fastening element from the magnetic spring clamp. An example of a fastening element may comprise a tack. The magnetic spring clamp may be utilized in conjunction with a security tag or another application in which spring clamps are known to be utilized or may be utilized in the future. For example, one embodiment of the invention comprises a magnetic spring clamp having a first jaw, a second jaw facing the first jaw and forming an opening between the first and second jaws, a first magnetic element coupled at an angle to the first jaw opposite the opening, a second magnetic element coupled at an angle to the second jaw opposite the opening, and at least one leaf spring attached to the first magnetic element and the second magnetic element to span the jaws. The magnetic spring clamp detacher has two facing magnets whose magnetization may be opposite in polarity and may be attractive to each other or may have the same polarity and be repellant to each other. The first magnetic element may form a first arm coupled substantially perpendicular to the first jaw and the second magnetic element may form a second arm coupled substantially perpendicular to the second jaw so as to apply a rotational force, or torque, to the jaws. That torque may furthermore be applied either to open or close the jaws. The first and second magnetic elements may be attached to the jaws of the spring clamp or may be formed on the jaws and each side of the spring clamp or any part thereof may be magnetized. First and second plates may furthermore extend from the first and second jaws respectively and be coupled to or formed with the magnetic arms.

In another embodiment, a security tag having a housing having an opening to contain a tack and containing an EAS device and a magnetic spring clamp is disclosed.

In yet another embodiment, a security system is disclosed. The security system may include a tag housing having an opening to retain a tack, an EAS device, a magnetic spring clamp, a tack, a detaching magnet, and an EAS monitor.

A method for applying force to a spring clamp having first and second facing jaws and at least one leaf spring spanning the jaws is also provided. The method may include forming a first magnetic element on the first jaw substantially perpendicular to the first jaw and forming a second magnetic element on the second jaw substantially perpendicular to the second jaw. The method may also include forming a first magnetic side arm on the first magnetic element substantially perpendicular to the first magnetic element and the facing jaws, forming a second magnetic side arm on the second magnetic element substantially perpendicular to the second magnetic element and the facing jaws, forming a third magnetic side arm on the first magnetic element substantially perpendicular to the first magnetic element and the facing jaws and opposite the first magnetic side arm and forming a fourth magnetic side arm on the second magnetic element substantially perpendicular to the second magnetic element and the facing jaws and opposite the second magnetic side arm. Moreover, the first and second magnetic side arms may be formed to overlap one another and the third and fourth magnetic side arms may be formed to overlap one another.

Although some embodiments may have elements that are described as having certain angles relative to other elements, such as the first and second magnetic side arms being substantial perpendicular to the first and second magnetic elements, it may be appreciated that these elements may use any angle and still fall within the scope of the embodiments.

Numerous specific details are set forth herein to provide a thorough understanding of the embodiments. It will be understood by those skilled in the art, however, that the embodiments may be practiced without those specific details. In other instances, well-known methods, procedures and components have not been described in detail so as not to obscure the embodiments. It can be appreciated that the specific structural and functional details disclosed herein may be representative and do not necessarily limit the scope of the invention.

One use for a spring clamp is in attaching security tags to items. Components of a security tag, other than those applicable to the magnetized spring clamp, are not illustrated herein so as not to obscure the structure and operation of the magnetic spring clamp, but are known to those skilled in the art. When utilized in connection with security tags, the spring clamp may be enclosed in a housing. The housing may be formed of a hard or rigid material that may be provided in two or more parts that are mated around the spring clamp. A usable rigid or hard material might be a hard plastic such as, for example, an injection molded ABS plastic or another material through which magnetic flux can penetrate. If a plastic is used, the mating side walls of the housings can be joined by an ultrasonic weld or a similar joining mechanism. The housing may furthermore include one or more interior cavities that may contain the spring clamp and an EAS device.

In a security tag application, an Electronic Article Surveillance (EAS) device may be included in the security tag. For example, an EAS device may generate a signal that is detectable by a detection apparatus and may be a magneto-mechanically resonating device. The types of detection apparatus and techniques suitable for use with the embodiments, however, are not limited in this context.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” or “in an embodiment” in various places in the specification are not necessarily all referring to the same embodiment. The word “or” is furthermore intended to be inclusive as used herein so that one or the other or any combination of ored elements are contemplated to be used in those circumstances.

The convention that negative distance or force corresponds to a repelling magnet and positive distance or force corresponds to an attracting magnet is utilized herein. Where magnets or magnetic components are referred to as “attracting” hereinafter, without further definition of the attractive components, that indicates that certain or all components of the spring clamp are attracted to a detaching magnet such as the detaching magnets illustrated in FIGS. 25-27. Similarly, where magnets or magnetic components are referred to as “repelling” hereinafter, without further definition of the repelling components, that indicates that certain or all components of the spring clamp are repelled from a detaching magnet such as the detaching magnets illustrated in FIGS. 25-27. Moreover, variations in distance correspond to the clamp shifting off center toward one of the magnets. In addition, for the left side of the clamp as shown in the embodiments described herein, a positive torque value corresponds to opening the clamp and negative torque corresponds to closing the clamp. The opposite is true for the right side of the clamp as shown in the embodiments described herein, wherein negative torque corresponds to opening the clamp and positive torque corresponds to closing the clamp.

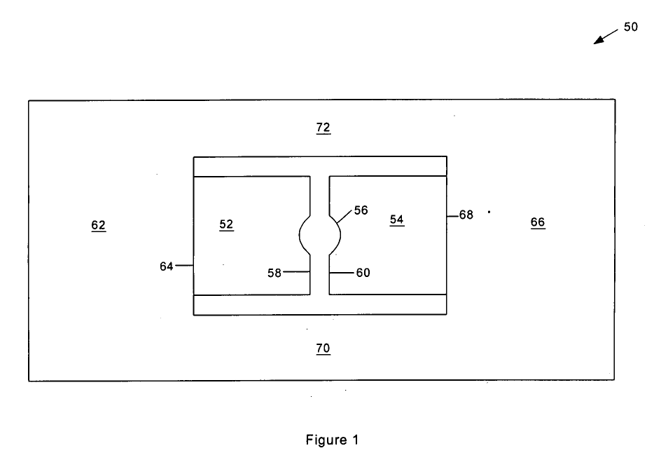

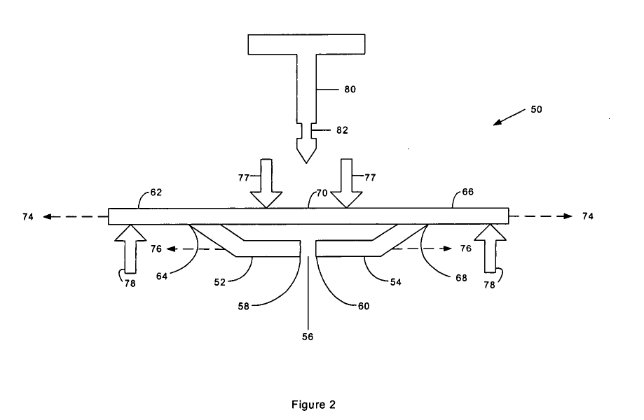

Referring now in detail to the drawings wherein like parts may be designated by like reference numerals throughout, FIG. 1 illustrates a top view of an embodiment of a spring clamp 50. The spring clamp 50 includes a first jaw 52 and a second jaw 54 having an opening 56 therebetween. The opening may separate the first jaw 52 and the second jaw 54 where the first jaw 52 and second jaw 54 terminate at a facing edge 58 of the first jaw and a facing edge 60 of the second jaw 54 and the opening 56 may be shaped to receive a tack 80 such as the one illustrated in FIG. 2, or another apparatus to be clamped. The first jaw 52 may further be attached to a first plate 62 at a fixed edge 64 of the first jaw 52 and the second jaw 54 may be attached to a second plate 66 at a fixed edge 68 of the second jaw 54. A first leaf spring 70 and a second leaf spring 72 may be disposed alongside of the jaws 52 and 54 perpendicular to the opening 56. The spring clamp 50 illustrated in FIG. 1 may, for example, be stamped from a single piece of steel. Thus, the plates 62 and 66 and leaf springs 70 and 72 may lie along a common spring plane 74. The jaws 52 and 54 may be angled from the plates 62 and 66 such that the opening 56 between the jaws 52 and 54 lies on a jaw plane 76 that is not on the spring plane 74.

It is worthy to note that tack 80 is one example of a fastening element that may be used to fasten a monitored item to a security tag using the various embodiments of a magnetic spring clamp as described herein. Although some embodiments may illustrate tack 80 as having a cylindrical shape with a pointed end, it may be appreciated that tack 80 may vary in shape and size as desired for a given implementation. For example, tack 80 may be implemented using any given cross-sectional shape, such as a circle, triangle, square, rectangle, oval, and so forth. Tack 80 may also be made of any suitable material that does not interfere with the magnetic elements and magnets as described herein. Further, tack 80 may be of any thickness, length, or width as desired for a given implementation. The embodiments are not limited in this context.

FIG. 2 illustrates a side view of the spring clamp 50 depicted in FIG. 1. When the spring clamp 50 is used to attach the security tag to an item, such as an article of clothing, the tack 80 may be inserted through the article of clothing and into a hole in the tag housing. The spring clamp 50 may be disposed within the tag housing to receive and retain the tack 80, thereby completing the attachment process. To detach the security tag, a magnetic detachment device that may be constructed as described in connection with FIGS. 25-27 may be used to apply force to the spring clamp 50. Once the force has been applied to the spring clamp 50, the tack 80 may be removed from the spring clamp 50 and tag housing to detach the security tag from the item.

In operation, the tack 80 or another apparatus may be pressed through the opening 56, passing first through the spring plane 74, with a light force that may generally be applied by a human hand because the jaws 52 and 54 may be easily spread to widen the opening 56 in that direction. In one embodiment, when the pointed end of tack 80 is inserted into the opening 56, jaws 52 and 54 may spread apart until a tack groove 82 aligns with the jaws 52 and 54. That alignment allows the jaws 52 and 54 to capture the tack 80. Once the jaws 52 and 54 capture the tack 80 at the tack groove 82, the jaws 52 and 54 may shift into the tack groove 82, thereby resisting extraction of the tack 80 from the opening 56. Pulling the tack 80 or other apparatus out of the opening 56 generally requires greater force than can be applied by a human hand because such pulling act tends to draw the jaws 52 and 54 closed, thereby reducing the opening 56 and tightening the pressure applied by the jaws 52 and 54 on the tack 80 or other apparatus.

To facilitate ease of removal of the tack 80 or other apparatus, an upward force may be applied to the plates 62 and 66 away from the jaw plane as illustrated at 78, and a downward force may be applied to the first leaf spring 70 and/or second leaf spring 72 as illustrated at 77, thereby causing the jaws 52 and 54 to separate and the opening to widen so that the force applied to the tack 80 or other apparatus by the jaws 52 and 54 is reduced and the tack 80 or other apparatus may generally be removed from the spring clamp 50 by hand.

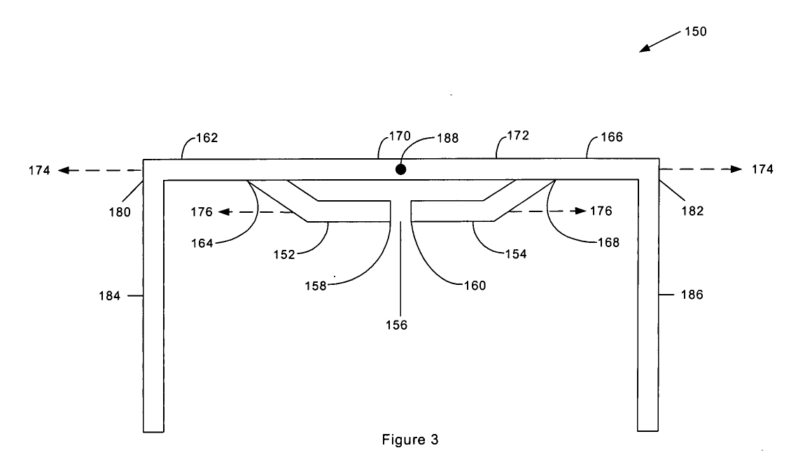

FIG. 3 illustrates an embodiment of a magnetic spring clamp 150 wherein plates 162 and 166 are magnetized and turned so as to form arms 184 and 186 that apply a rotational force at the ends of spring plane 174. Such an extended clamp geometry may provide high permeability for enhanced magnetic response and mechanical leverage over previous spring clamps. The magnetic interaction of the plates 162 and 166 may also enhance the mechanical output of the spring clamp 150. It should be recognized that jaws 152 and 154 and/or leaf springs 170 and 172 may also be magnetized and the entire spring clamp 150 may be magnetized if desired. The magnetic spring clamp 150 is illustrated having a first half 180 and a second half 182 separated at the opening 156, and those halves may be formed as two separate pieces or a single piece. Each half 180 and 182 may furthermore be magnetized so that the halves 180 and 182 are attracted by a detaching magnet such as those illustrated in FIGS. 25-27 or so that the halves 180 and 182 are attracted to a detaching magnet so as to apply a desired force to the magnetic spring clamp 150.

For example, where the halves 180 and 182 are attracted to a detaching magnet positioned around the arms 184 and 186 of the spring clamp 150, a force causing the arms 184 and 186 to tend to move away from each other may be applied. When such a force causing the arms 184 and 186 to move or tend to move away from each other is applied, a rotational force is created about a point or axis 188 intermediate the jaws 152 and 154 that tends to move the jaws 152 and 154 apart, thereby loosening the grip of the jaws 152 and 154 on the tack 80.

It is worthy to note that by having the arms 184 and 186 arranged so that a force is needed to cause the arms 184 and 186 to tend to move away from each other in order to loosen the grip of jaws 152 and 154 may provide several advantages with respect to preventing defeat of the security features of the security tag. For example, since magnetic spring claim 150 is typically positioned within a tag housing, a person attempting to remove the security tag without proper authorization may have difficulty accessing the arms 184 and 186 to provide the appropriate force needed to release tack 80. Consequently, a person would have difficulty defeating the security features of magnetic spring claim 150 using a pair of pliers or other tool designed to provide inwardly directing force to the arms 184 and 186.

The spring clamp 150 of FIG. 3 also includes a facing edge 158 and a fixed edge 164 of the first jaw, and a facing edge 160 and a fixed edge 168 of the second jaw 54, which may be similar to the elements 58, 64, 60, and 68 respectively, illustrated in FIGS. 1 and 2. The spring clamp 150 of FIG. 3 also includes a jaw plane 176 along which the jaws 152 and 154 lie.

It may be seen that where the two halves 180 and 182 or parts thereof are magnetized, a bent portion or arm 184 of the first half 180 extending at an angle such as perpendicular to the spring plane 174 and a bent portion or arm 186 of the second half 182 extending at an angle such as perpendicular to the spring plane 174 will apply a force about an axis 188 lying approximately where the halves 180 and 182 meet. In that way, a desired force may be applied to the leaf springs 170 and 172 to open the jaws 152 and 154 as desired. For example, where the halves 180 and 182 are attracted to a detaching magnet such as those illustrated in FIGS. 25-27 when the first detacher magnet is placed next to the first half 180 and the second detacher magnet is placed next to the second half 182, the jaws 152 and 154 may be drawn open to ease removal of a tack.

In an embodiment, the halves 180 and 182 were magnetized to be attracted to a detaching magnet, such as the one shown in FIG. 25, and the turned portions 184 and 186 were turned perpendicular to the spring plane 174 toward the jaw plane 176, as illustrated in FIG. 3. The detaching magnets used by the detacher are spaced 18 mm apart and created a torque of 0.012 Nm on the halves 180 and 182 when the first and second magnetic elements were placed next to the arms 184 and 186.

FIG. 4 illustrates an isometric view of another embodiment of a magnetic spring clamp 150, wherein like elements are referenced with numbers matching the numbers used in FIG. 3. The spring clamp 150 of FIG. 4 includes plates 162 and 166 having arms 184 and 186 that are magnetized and turned such that nearly the entirety of each plate 162 and 166 is positioned at an angle from the leaf springs 170 and 172. It should be recognized that rather than bending or forming the plates at an angle to the leaf springs 170 and 172 to form magnetic arms 184 and 186, a magnetic first arm 184 may be attached to the first plate 162 or first jaw at such an angle and a magnetic second arm 186 may be attached to the second plate 166 or second jaw. Moreover, only the arms 184 and 186 may be magnetized or the arms 184 and 186 and all or portions of the plates 162 and 166, jaws 152 and 154, and leaf springs 170 and 172 may be magnetized as well.

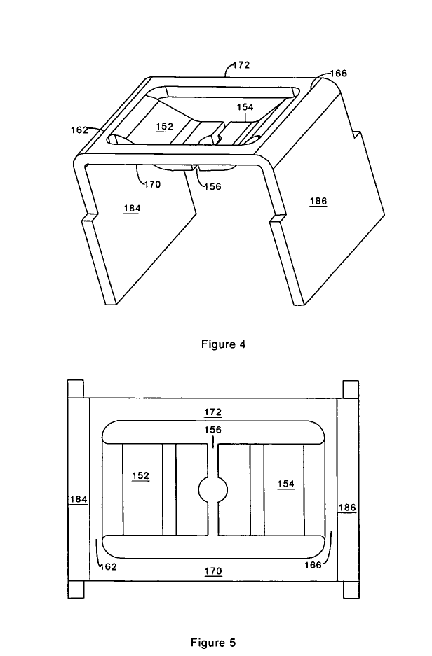

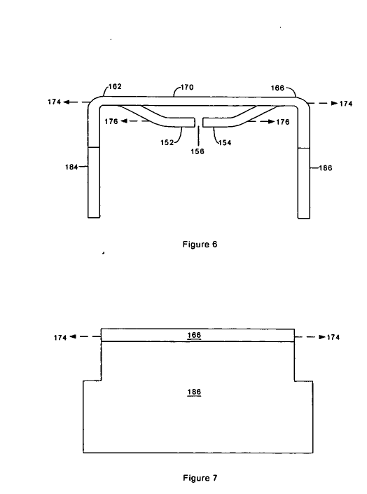

FIG. 5 illustrates a top view of the spring clamp 150 of FIG. 4, while FIG. 6 illustrates a side view of the spring clamp 150 of FIG. 4 and FIG. 7 illustrates an end view of the spring clamp 150 of FIG. 4.

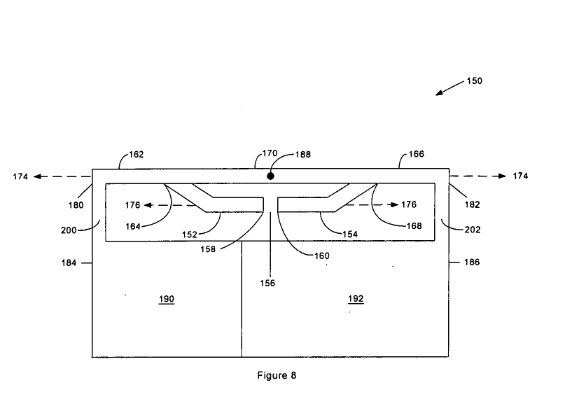

FIG. 8 illustrates a side view of another embodiment of a spring clamp 150 that includes a first side arm 190 extending from a first side 200 of the first arm 184 and a second side arm 192 extending from a first side 202 of the second arm 186. Alternately, a magnetic block or other shape may extend from each arm 184 and 186 to create the desired magnetic effect.

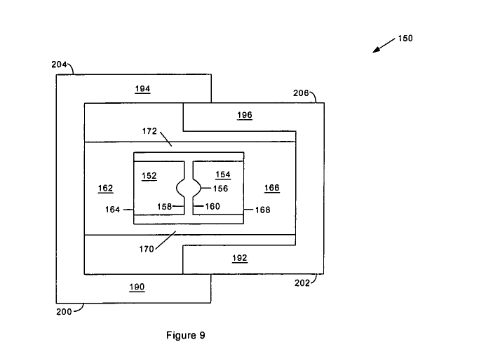

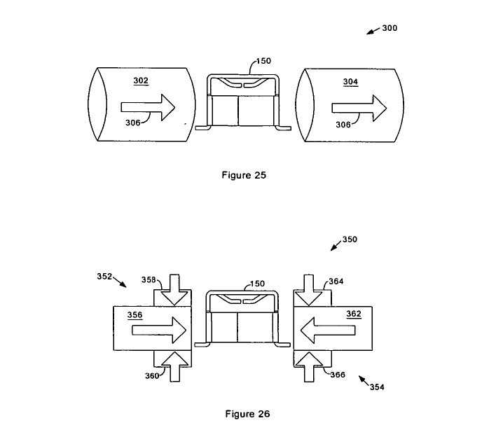

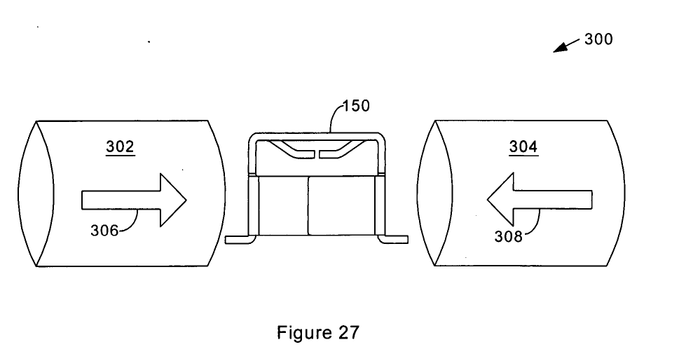

FIG. 9 illustrates a top view of the spring clamp 150 with side arms 190 and 192 depicted in FIG. 8. FIGS. 9-11 shows that a third side arm 194 may extend from a second side 204 of the first arm 184 opposite the first side arm 190 and a fourth side arm 196 may extend from a second side of the second arm 186 opposite the second side arm 192. The first side arm 190 may overlap but does not necessarily need to make contact with the second side arm 192, and the third side arm 194 may overlap but does not necessarily need to make contact with the fourth side arm 196 as illustrated in FIGS. 9-11. The first through fourth side arms 190-196 may also form a flux path that channels magnetic flux from one half of the spring clamp 180 to the other side of the spring clamp 182, thereby enhancing the forces between the halves of the clamp 180 and 182. That magnetic flux may furthermore assist a detacher magnet such as the detacher magnets 300 illustrated in FIGS. 25 and 27 or the detacher magnet 350 illustrated in FIG. 26 that may be utilized when removing the tack 80 or other apparatus disposed between the jaws 152 and 154 of the spring clamp 150. Moreover, various geometric configurations and selections of materials with appropriate magnetic properties of the arms and side arms may be devised to achieve different strengths as desired for each application of the magnetic spring clamp.

In an embodiment utilizing the configuration illustrated in FIGS. 8 and 9, overlapping side arms 190-196 are attached to or formed with the side arms 184 and 186 to assist in opening the jaws 152 and 154 when a detacher magnet is applied to the spring clamp 150. The first half 180 and second half 182 may be oppositely polarized by use of magnets such as a north polarized magnet utilized for the first arm 184 facing a south polarized magnet utilized for the second arm 186. In that embodiment, the magnetization of the arms 184 and 186 causes the arms 184 and 186 to be attracted to an appropriate detacher magnet such as the detacher magnet 300 or the detacher magnet 350 of FIG. 26, and the magnetization at the open ends of the overlapping side arms 190-196 produces a similar attractive force with the detacher magnet. Those attractive forces may apply force to open the jaws 152 and 154 when the spring clamp 150 is configured as illustrated in FIGS. 8 and 9 by causing the jaws 152 and 154 to rotate about the axis 188 running through the spring plane 174 between the first half 180 and second half 182, thereby rotating plates 166 and 162 upwards and away from plane 174 thus moving the facing edges 158 and 160 of the jaws 152 and 154 away from opening 156.

When overlapping the side arms 190-196, the interaction of the side arms 190-196 may be increased by placing the side arms 190-196 in close proximity. In an embodiment wherein the side arms 190-196 were placed in close proximity and magnetized to move the jaws toward an open position when a detacher magnet is applied, the torque created by side arms 190-196 having an overlap of 1 mm was in excess of 0.015 Nm, the torque created by side arms 190-196 having an overlap of 3 mm was just under 0.015 Nm, and the torque created by side arms 190-196 having an overlap of 5 mm was in excess of 0.010 Nm.

FIG. 10 illustrates an isometric view of another embodiment of a magnetic spring clamp 150 having overlapping side arms 190-196, wherein like elements are referenced with numbers matching the numbers used in FIGS. 8 and 9. The magnetic spring clamp 150 illustrated in FIG. 10 may be formed from a single piece of metal by stamping the metal out at the opening 156 and around the jaws 152 and 154 and then bending the metal into the shape illustrated. The magnetic spring clamp 150 illustrated in FIG. 10 may be formed otherwise by attaching a magnetic element 184, 190 and 194 to the first jaw 152 and the leaf springs 170 and 172 and attaching another magnetic element 186, 192 and 196 to the second jaw 154 and the leaf springs 170 and 172.

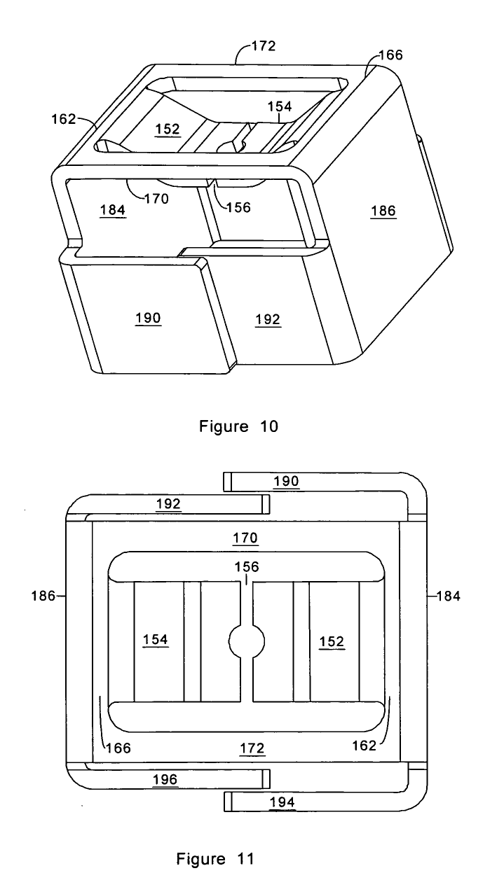

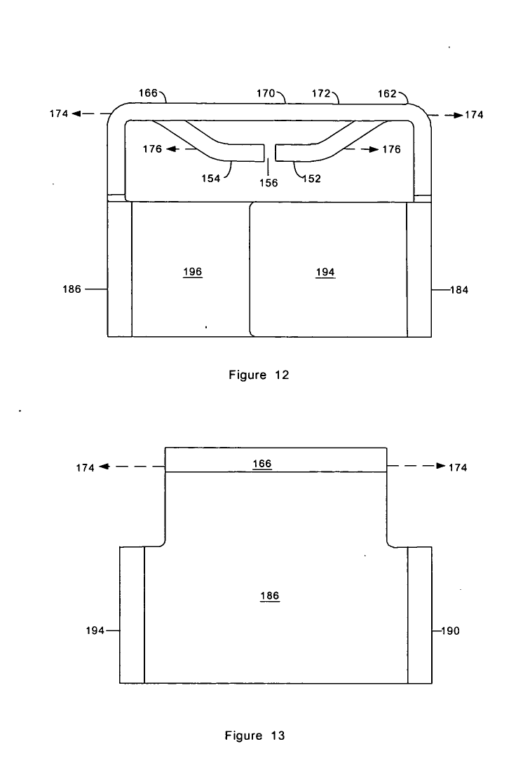

FIG. 11 illustrates a top view of the spring clamp 150 of FIG. 10, while FIG. 12 illustrates a side view of the spring clamp 150 of FIG. 10 and FIG. 13 illustrates an end view of the spring clamp 150 of FIG. 10.

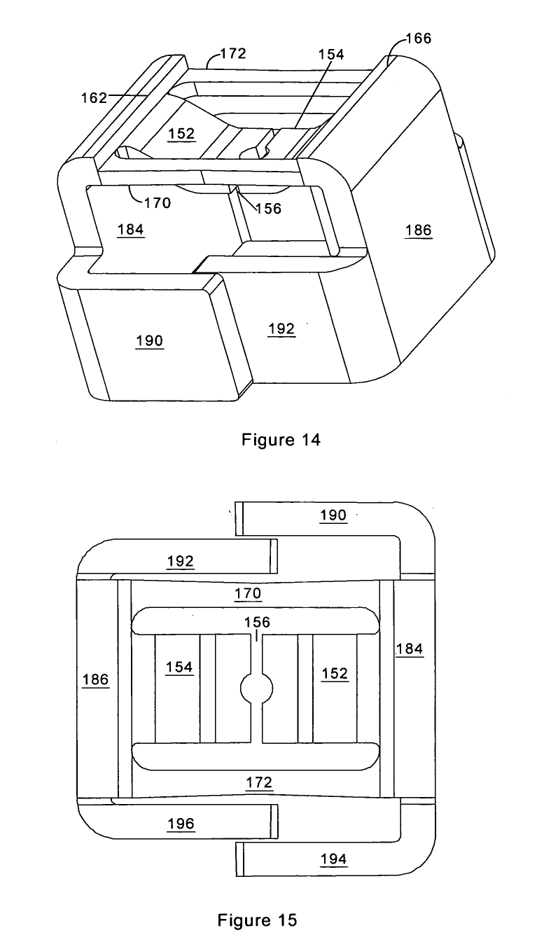

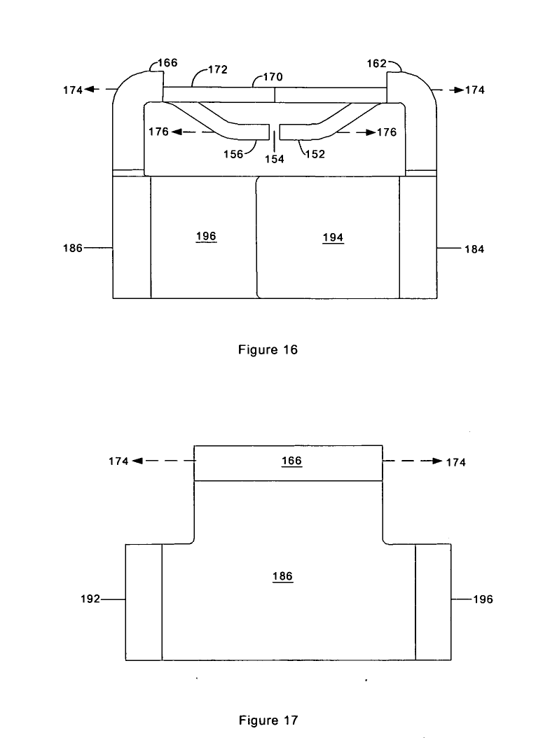

FIG. 14 illustrates an isometric view of an embodiment of a spring clamp 150 wherein the arms 184 and 186 and side arms 190-196 are thicker than the other components of the spring clamp 152, 154, 162, 166, 170 and 172 to increase the magnetic force developed by the arms 184 and 186 and side arms 190-196. FIG. 15 illustrates a top view of the spring clamp 150 of FIG. 14, while FIG. 16 illustrates a side view of the spring clamp 150 of FIG. 14 and FIG. 17 illustrates an end view of the spring clamp 150 of FIG. 14.

The effect of thickening the arms 184 and 186 and side arms 190-196 was also determined for an embodiment of the magnetic spring clamp 150. In a first configuration, both halves 180 and 182 of the clamp 150 were magnetized and formed to a thickness of 0.5 mm. The torque provided by interaction of a detacher magnet with that configuration was found to be 0.018 Nm. In a second configuration, both halves 180 and 182 of the clamp 150 were magnetized and formed to a thickness of 1.0 mm. The torque provided by interaction of a detacher magnet with that configuration was found to be 0.029 Nm. Thus, a thickening of the halves 184 and 186 may create increased torque where such increased torque is desired.

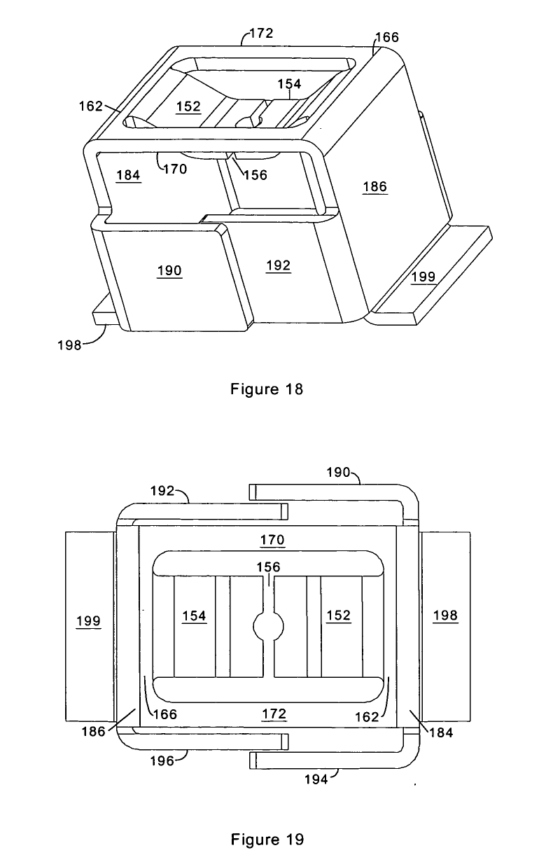

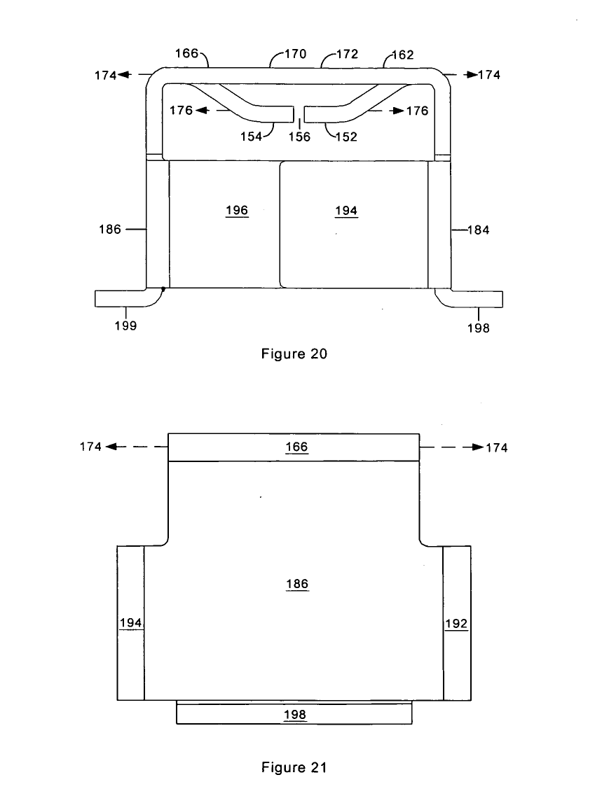

FIG. 18 illustrates an embodiment of a spring clamp 150 having a first flange 198 extending from an edge of the first side arm 184 opposite the first plate 162 and a second flange 199 extending from an edge of the second side arm 186 opposite the second plate 166. The addition of such flanges 198 and 199 may enhance the torque of the magnetic or partially magnetic halves 180 and 182. For example, addition of 0.5 mm thickness flanges 198 and 199 on each arm 184 and 186 respectively, bending away from the side arms 190-196 and formed on the arms 184 and 186 opposite the plates 162 and 166 while interacting with a detacher magnet was found to create a torque on the jaws 152 and 154 of 0.051 Nm. FIG. 19 illustrates a top view of the spring clamp 150 of FIG. 18, while FIG. 20 illustrates a side view of the spring clamp 150 of FIG. 18 and FIG. 21 illustrates an end view of the spring clamp of FIG. 18.

Also, the length of the arms 184 and 186 may be changed to increase or decrease leverage on the jaws 152 and 154 or other changes in dimension or configuration may be made to the magnetic spring clamp 150 to create the desired force on the jaws 152 and 154 and create that force either to open or close the jaws 152 and 154.

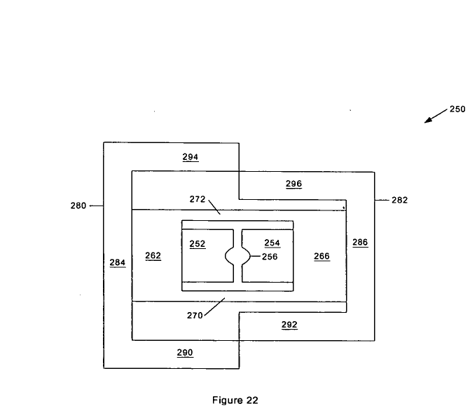

As illustrated in FIG. 22, the side arms may alternately not overlap. In FIG. 22, a first side arm 290 that extends from a first arm 284 does not overlap a second side arm 292 that extends from a second side arm 286, and a third side arm 294 that extends from the first arm 284 does not overlap a fourth side arm 296 that extends from the second side arm 286. Where the side arms 290-296 do not overlap and halves 280 and 282 are the same polarity upon exposure to the field from the detacher magnets with repellant configuration, while the arms 284 and 286 are attracted by their adjacent detacher magnet the side arms 290-296 weakly repel each other causing the arms 284 and 286 to move away from each other, causing the jaws 252 and 254 to move away from opening 256. In that way, the jaws 252 and 254 will be moved toward an open position around the tack 80 or other apparatus or place less closing force around the tack 80 or other apparatus. A pair of repelling magnets, such as a north polarized magnet coupled to the first half 280 and a north polarized magnet coupled to the second half 282 may create a small repulsion between the open ends of the side arms 290-296 while dominated by the attractive force of the detacher magnet on the arms 284 and 286 to cause the clamp to open.

In a configuration wherein the side arms 290-296 are not overlapping and are attracted to each other upon exposure to the field from the attracting detacher magnets, the jaws 252 and 254 will be more securely closed around the tack 80 or other apparatus to provide defeat resistance by resisting removal of the tack 80 or other apparatus from between the jaws 252 and 254.

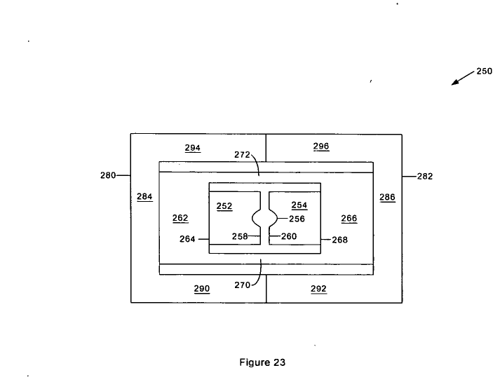

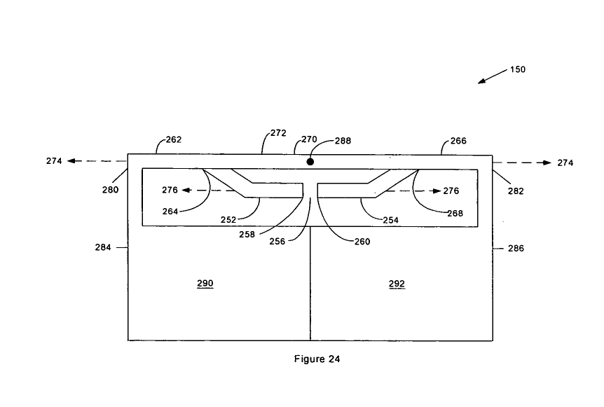

Side arms 290-296 that do not overlap may be offset like the side arms 290-296 illustrated in FIG. 22, or side arms 290-296 that do not overlap may directly oppose one another as illustrated in FIG. 23. With a pair of attracting magnets, a north (south) polarized first half 280 and a south (north) polarized second half 282 may create an attracting force between the open ends of the side arms 290-296 that counters the opening force due to the attraction by the detacher magnet on the magnetic elements 284 and 286 and prevent opening or sufficient opening of gap 156 for extraction of tack 80.

FIG. 24 illustrates a side view of a magnetic spring clamp 250 having non-overlapping side arms 290-296.

FIG. 25 illustrates an embodiment of a detaching magnet 300 for use in removing a tack 80 or other apparatus inserted into an embodiment of the spring clamp. The detaching magnet 300 of FIG. 25 includes a first detaching magnet 302 and a second detaching magnet 304 that are attracting NdFeB magnets. Other magnets or arrangements may be used where suitable for a particular application. The first detaching magnet 302 may, for example, be positioned near the first arm 184 of the spring clamp 150 illustrated in FIGS. 3-21 and 28-32 or near the first arm 284 of the spring clamp 250 illustrated in FIGS. 22-24 and the second detaching magnet 304 may be positioned near the second arm 186 of the spring clamp 150 illustrated in FIGS. 3-21 and 28-32 or near the second arm 286 of the spring clamp 250 illustrated in FIGS. 22-24 to reduce the clamping force on the jaws 152 and 154 or 252 and 254 when the tack 80 is being removed. The detaching magnet 300 may, for example, apply a rotational force on the arms of the spring clamp of approximately 0.051 Nm.

The first detaching magnet 302 and second detaching magnet 304 may be polarized relative to one another in a number of different ways. When applied to an overlapping spring clamp such as the spring clamp 150 illustrated in FIG. 8-21, the first detaching magnet 302 and second detaching magnet 304 may be polarized in the same direction as shown at 306. Alternatively, the first detaching magnet 302 and second detaching magnet 304 may be polarized in opposite directions at the second half 182 of the spring clamp 150 as shown at 308 in FIG. 27.

FIG. 26 illustrates another embodiment of a detaching magnet 350 for use in removing a tack 80 or other apparatus inserted into an embodiment of the spring clamp. That embodiment 300 may provide a higher concentration of flux than the detaching magnet 250 illustrated in FIGS. 25 and 27, while utilizing a lesser total mass of magnet. Thus, the detaching magnet 350 depicted in FIG. 26 may provide the desired force in a configuration that is more compact than the detaching magnet 300 depicted in FIGS. 25 and 27. The detaching magnet 350 includes a first decoupler 352 and a second decoupler 354. When used to decouple a tack 80 from the spring clamp 150 such as those illustrated in FIGS. 3-24 and 28-32, for example, the first decoupler 352 may include a magnet 356 with a right pointing magnetization one or more magnets 358 and 360 having flux directed toward the magnet 356 coupled to the magnet 356. The second decoupler 354, may include a magnet 362 with left pointing magnetization with one or more magnets 364 and 366 having flux directed toward the magnet 362. That configuration may provide a more compact detaching magnet 350 than the detaching magnets 300 illustrated in FIGS. 25 and 27, and one that has a surface fitted more suitably to the size of a spring clamp. It should be recognized that other decoupler configurations may be provided to suit the configuration, polarization, and force provided by any desired spring clamp.

The detaching magnets 300 and 350 illustrated in FIGS. 25-27, for example, may be provided so as to recognize that high field repelling magnets may be more difficult to handle and use for unauthorized detaching of a tack 80 from a spring clamp than attracting magnets. That is because when decoupling using attracting magnets, a first magnetic element may be set on a surface, the tag clamp may be placed on the first magnetic element, and a second attracting magnet may be placed on the spring clamp opposite the first magnetic element, due to the attractive force of those three components. Whereas an unauthorized person attempting to decouple a tack 80 from a spring clamp would likely need to use one hand to press each of the repelling magnets against opposite sides of the spring clamp and a third hand to remove the tack 80.

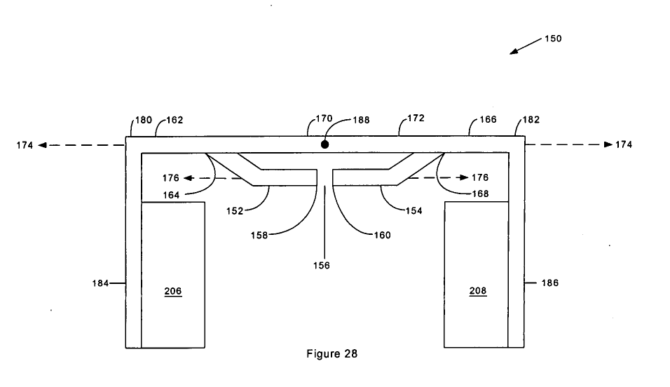

FIG. 28 illustrates a side view of an embodiment of a magnetic spring clamp 150 having plates 162 and 166 turned to form arms 184 and 186 and having a first magnet 206 coupled to the first arm 184 magnetically or mechanically and a second magnet 208 coupled to the second arm 186 magnetically or mechanically. The first magnet 206 and the second magnet 208 may be any desired size and may be attached to any desired portion of the arms 184 and 186. In the embodiment illustrated in FIG. 28, the first and second magnets 206 and 208 apply a rotational force at the ends of the spring plane 174 through the first and second arms 184 and 186. That extended clamp geometry may also provide enhanced magnetic response and mechanical leverage over previous spring clamps. A detaching magnet, such as those illustrated in FIGS. 25-27 may be utilized to apply a desired force to the magnetic spring clamp 150 with magnets 206 and 208 coupled to the arms 184 and 186.

It may be seen that first and second magnets 206 and 208 applied to first and second arms 184 and 186 as illustrated in FIG. 28 when interacting with detacher magnets in FIGS. 26 and 27, may apply a force about an axis 188 lying approximately where the halves 180 and 182 meet. In that way, a desired force may be applied to the leaf springs 170 and 172 to open the jaws 152 and 154 as desired.

For example, where the magnets 206 and 208 are attracted to a detaching magnet, such as those illustrated in FIGS. 25-27, positioned around the arms 184 and 186 of the spring clamp 150, a force causing the magnets 206 and 208 and the arms 184 and 186 coupled thereto to tend to move away from each other may be applied. When such a force causing the magnets 206 and 208 and the arms 184 and 186 to move or tend to move away from each other is applied, a rotational force is created about a point or axis 188 intermediate the jaws 152 and 154 that tends to move the jaws 152 and 154 away from the spring plane 174, thereby loosening the grip of the jaws 152 and 154 on the tack 80.

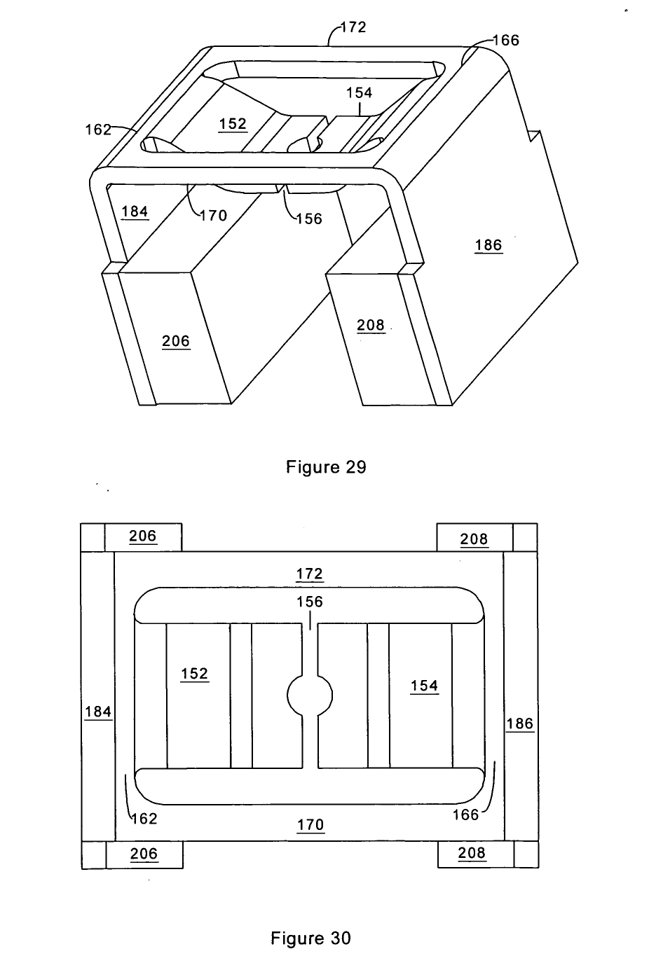

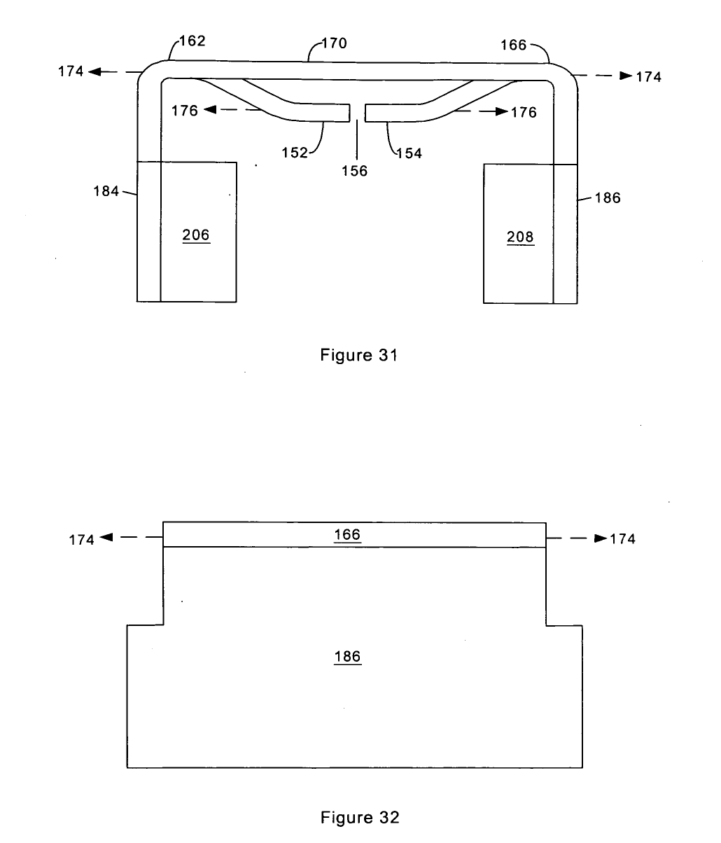

FIG. 29 illustrates an isometric view of another embodiment of a magnetic spring clamp 150, having first and second magnets 206 and 208 coupled to the first and second arms 184 and 186 respectively. FIG. 30 illustrates a top view of the spring clamp 150 of FIG. 29, while FIG. 31 illustrates a side view of the spring clamp 150 of FIG. 29 and FIG. 32 illustrates an end view of the spring clamp 150 of FIG. 29.

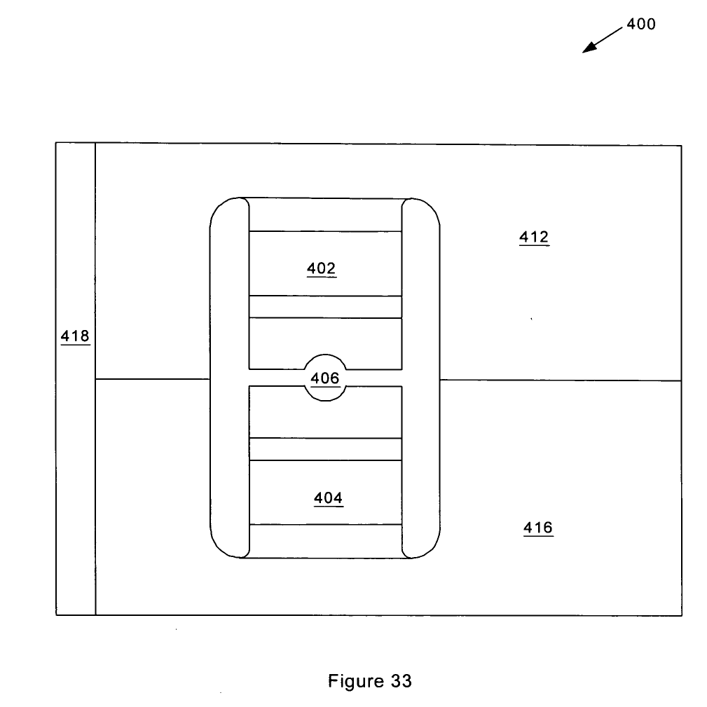

FIG. 33 illustrates an embodiment of a two plate spreading symmetric jaw magnetic spring clamp 400. The two plate spreading symmetric jaw magnetic spring clamp 400 includes a first jaw 402 and a second jaw 404 having an opening 406 therebetween. The first jaw 402 is attached to a first magnetic element 412 and the second jaw 404 is attached to a second magnetic element 416. A displaceable coupler 418 couples the first magnetic element 412 to the second magnetic element 416. The displaceable coupler 418 may, for example, be a spring material that places a bias on the first magnetic element 412 and the second magnetic element 416 to close the opening 408 between the first jaw 402 and the second jaw 404.

In operation, a tack, such as the tack 80 illustrated in FIG. 1, or other apparatus may be secured between the first jaw 402 and the second jaw 404. When a detacher magnet with repellant configuration such as the detacher magnets 350 illustrated in FIGS. 26 and 300 illustrated in FIG. 27 is applied to the first magnetic element 412 and the second magnetic element 416, the first jaw 402 and the second jaw 404 may move away from one another to widen the opening 406 or force may be applied to the first jaw 402 and the second jaw 404 that reduces the pressure applied to the tack 80 or other apparatus disposed between the first jaw 402 and the second jaw 404. When the detacher magnet with attractive configuration such as the detacher magnet 300 in FIG. 25 is applied, magnetic elements 412 and 416 are magnetized in different polarity. The attractive force between 412 and 416 counters the opening force due to the attraction by the detacher magnet on the magnetic elements 412 and 416 and prevent opening or sufficient opening of 406 for extraction of tack 80.

The first magnetic element 412 and second magnetic element 416 may, for example, be flat, unbent plates and may lie along a plane that substantially coincides with a plane in which the first jaw 402 and the second jaw 404 lie.

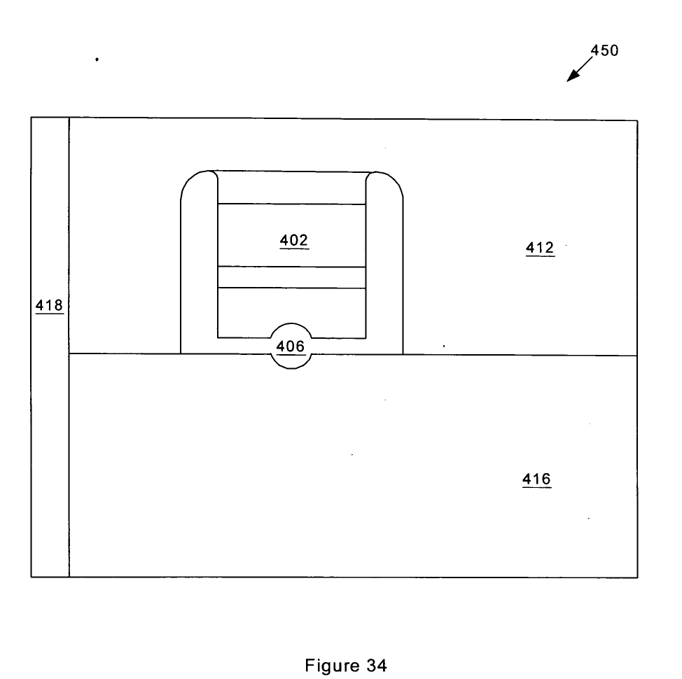

FIG. 34 illustrates an embodiment of a two plate spreading asymmetric jaw magnetic spring clamp 450. The two plate spreading asymmetric jaw magnetic spring clamp 450 includes a first jaw 402 attached to a first magnetic element 412. The two plate spreading asymmetric jaw magnetic spring clamp 450 may be similar to the two plate spreading symmetric jaw magnetic spring clamp 400 but includes a second jaw that is different from the second jaw 404 of the two plate spreading symmetric jaw magnetic spring clamp 400 as illustrated in FIG. 33. Rather, the second jaw of clamp 450 is integrated with a second magnetic element 416, with the second jaw forming a shape conforming to slightly more than half the diameter of the tack 80 to accommodate the tack 80 when inserted between the first and second jaws. The two plate spreading asymmetric jaw magnetic spring clamp 450 includes a second magnetic element 416 and a displaceable coupler 418 with the displaceable coupler 418 attached to the first magnetic element 412 and the second magnetic element 416.

In operation, a tack 80 or other apparatus may be placed between the first jaw 402 and the second magnetic element 416 and held in place therebetween. When a detacher magnet with a repellant configuration such as the detacher magnets 350 illustrated in FIGS. 26 and 300 illustrated in FIG. 27 is applied to the first magnetic element 412 and the second magnetic element 416, the first jaw 402 and the second magnetic element 416 may move away from one another to widen the opening 406 or apply force to the first jaw 402 and the second magnetic element 416 that reduces the pressure applied to the tack 80 or other apparatus disposed between the first jaw 402 and the second magnetic element 416. When the detacher magnet with attractive configuration such as the detacher magnet 300 in FIG. 25 is applied, magnetic elements 412 and 416 are magnetized in different polarity. The attractive force between 412 and 416 counters the opening force due to the attraction by the detacher magnet on the magnetic elements 412 and 416 and prevent opening or sufficient opening of 406 for extraction of tack 80.

While certain features of the embodiments have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A spring clamp, comprising:
a first jaw;
a second jaw facing the first jaw and forming an opening between the first and second jaws;
a first magnetic element coupled at an angle to the first jaw;
a second magnetic element coupled at an angle to the second jaw; and
at least one leaf spring attached to the first magnetic element and the second magnetic element.

2. The spring clamp of claim 1, further comprising a first magnet and a second magnet to attach to the first magnetic element and the second magnetic element, respectively, wherein the first magnet and the second magnet are polarized to repel one another.

3. The spring clamp of claim 1, wherein the first magnetic element is coupled substantially perpendicular to the first jaw and the second magnetic element is coupled substantially perpendicular to the second jaw.

4. The spring clamp of claim 1, wherein the first and second magnetic elements are formed on the first and second jaws respectively.

5. The spring clamp of claim 1, wherein the first and second magnetic elements are attached to the first and second jaws respectively.

6. The spring clamp of claim 1, wherein the first magnetic element includes a first side having a first side arm extending at an angle therefrom and a second side having a third side arm extending at an angle therefrom, and the second magnetic element includes a first side having a second side arm extending at an angle therefrom and a second side having a fourth side arm extending at an angle therefrom.

7. The spring clamp of claim 6, wherein the first magnetic element, the first side arm and the third side arm form a U-shape and the second magnetic element, the second side arm and the fourth side arm form a U-shape.

8. The spring clamp of claim 6, wherein the first side arm faces the second side arm and the third side arm faces the fourth side arm.

9. The spring clamp of claim 6, wherein the first side arm overlaps the second side arm and the third side arm overlaps the fourth side arm.

10. The spring clamp of claim 1, further comprising a first plate attaching the first jaw to the first magnetic element and a second plate attaching the second jaw to the second magnetic element.

11. The spring clamp of claim 1, further comprising a second leaf spring attached to the first magnetic element and the second magnetic element.

12. A security tag, comprising
a tag housing having an opening to retain a fastening element;
an electronic article surveillance device disposed within the tag housing; and
a spring clamp disposed within the tag housing, the spring clamp having first and second jaws, the first jaw having a magnetic element formed at an angle therefrom and the second jaw having a magnetic element formed at an angle therefrom, and at least one leaf spring attached to the opposing magnets and spanning the jaws.

13. The security tag of claim 12, wherein said fastening element comprises a tack to be disposed through the housing and the spring clamp.

14. The security tag of claim 12, wherein the first and second magnetic elements are attractive.

15. The security tag of claim 12, wherein the first and second magnetic elements are repellant.

16. The security tag of claim 12, wherein the first and second magnetic elements are formed on the jaws.

17. The security tag of claim 12, wherein the first and second magnetic elements are attached to the jaws.

18. The security tag of claim 12, wherein first and second magnetic elements are coupled substantially perpendicular to the jaws.

19. The security tag of claim 18, wherein the first and second magnetic elements apply a force to rotate the jaws about an axis between the jaws.

20. The security tag of claim 12, wherein the first magnetic element includes a first side having a first side arm extending at an angle therefrom and a second side having a third side arm extending at an angle therefrom, and the second magnetic element includes a first side having a second side arm extending at an angle therefrom and a second side having a fourth side arm extending at an angle therefrom.

21. The security tag of claim 20, wherein the first side arm faces the second side arm and the third side arm faces the fourth side arm.

22. The security tag of claim 20, wherein the first side arm overlaps the second side arm and the third side arm overlaps the fourth side arm.

23. A security system, comprising
a tag housing having an opening to retain a tack;
an electronic article surveillance device disposed within the tag housing;
a spring clamp disposed within the tag housing, the spring clamp having first and second jaws, the first jaw having a magnetic element formed at an angle therefrom and the second jaw having a magnetic element formed at an angles therefrom, and at least one leaf spring attached to the opposing magnets and spanning the jaws;
a fastening element to be disposed through the opening in the tag housing and the spring clamp;
a detaching magnet to permit removal of the fastening element; and
a electronic article surveillance monitor to detect the presence of the electronic article surveillance device.

24. The security system of claim 23, wherein the first magnetic element includes a first side having a first side arm extending at an angle therefrom and a second side having a third side arm extending at an angle therefrom, and the second magnetic element includes a first side having a second side arm extending at an angle therefrom and a second side having a fourth side arm extending at an angle therefrom.

25. The security system of claim 23, wherein the first side arm overlaps the second side arm and the third side arm overlaps the fourth side arm.

26. A method of applying force to a spring clamp having first and second facing jaws forming an opening therebetween and at least one leaf spring spanning the jaws, comprising:
forming a first magnetic element on the first jaw substantially perpendicular to the first facing jaw; and
forming a second magnetic element on the second jaw substantially perpendicular to the second facing jaw.

27. The method of claim 26, wherein the first magnetic element and the second magnetic element are arranged to apply force to rotate the jaws about an axis between the jaws.

28. The method of claim 26, further comprising:
forming a first magnetic side arm on the first magnetic element substantially perpendicular to the first magnetic element and the facing jaws; and
forming a second magnetic side arm on the second magnetic element substantially perpendicular to the second magnetic element and the facing jaws;
forming a third magnetic side arm on the first magnetic element substantially perpendicular to the first magnetic element and the facing jaws and opposite the first magnetic side arm; and
forming a fourth magnetic side arm on the second magnetic element substantially perpendicular to the second magnetic element and the facing jaws and opposite the second magnetic side arm.

29. The method of claim 28, further comprising:
overlapping the first and second magnetic side arms; and
overlapping the third and fourth magnetic side arms.

30. A spring clamp, comprising:
a first jaw;
a second jaw facing the first jaw and forming an opening between the first and second jaws;
a first magnetic element attached to the first jaw;
a second magnetic element attached to the second jaw; and
a displaceable coupler attached to the first magnetic element and the second magnetic element.

31. The spring clamp of claim 30, wherein the second jaw is integrated with the second magnetic element.
